(19) United States
(12) Patent Application Publication
(10) Pub. No.: US 2004/0103027 A1
(43) Pub. Date: May 27, 2004

(54) Advertisement distributing server system, and advertise distributing method

(76) Inventors: Katsuyuki Yamamoto, Tokyo-to (JP); Mamoru Ikegashira, Tokyo-to (JP); Toshimichi Nishikawa, Tokyo-to (JP); Yasuhiro Fujioka, Tokyo-to (JP)

Correspondence Address: Richard J Streit, Ladas & Parry, Suite 1200, 224 South Michigan Avenue, Chicago, IL, 60604, US

(21) Appl. No.: 10/470,425

(22) PCT Filed: Jan. 29, 2002
(86) PCT No.: PCT/JP02/00650

(30) Foreign Application Priority Data
Jan. 29, 2001 (JP) 2001-020667
Oct. 25, 2001 (JP) 2001-327570

(51) Int. Cl. G06F 17/60

(52) U.S. Cl. 705/14

(57) ABSTRACT

The advertisement distributing server system includes an advertiser database which stores advertising information including brief advertisement images and exclusive advertisement pages for a plurality of advertisers; a brief advertisement image display unit which displays the brief advertisement images associated with the plurality of advertisers stored in the advertiser database on a browser screen of the terminal in a switched manner switched at a predetermined time interval in accordance with a request from a client terminal; and an exclusive advertisement page display unit which displays the exclusive advertisement page of the advertiser stored in the advertiser database on the browser screen when a certain brief advertisement image is selected. Therefore, unlike the banner advertisement accompanying to a portal site for search, the advertisement is distributed via the exclusive advertisement site collecting only the advertising information, and hence the advertisement plays the leading part and the remarkable enhancement of the advertising effect can be expected.

### TECHNICAL FIELD

This invention relates to the distribution of advertisement by utilizing a network which connects the Internet, a communication, a digital broadcasting, a mobile terminal device, a car navigation device and so on.

### TECHNICAL BACKGROUND

Conventionally, various ways are proposed as advertisement providing means by utilizing a network such as the Internet. However, most of them are the banner advertisement and mail advertisement appearing at the portal site for information search, and distributing the advertisement closely associated with the shops and the communities, such as the advertising catalogs inserted in the newspapers, via a network such as the. Internet is not performed.

### DISCLOSURE OF INVENTION

An object of the present invention is to provide an advertisement distributing server system and an advertisement distributing method which distribute advertisement by using a network such as the Internet or a local area network.

According to one aspect of the present invention, there is provided an advertisement distributing server system including: an advertiser database which stores advertising information including brief advertisement images and exclusive advertisement pages for a plurality of advertisers; a brief advertisement image display unit which displays the brief advertisement images associated with the plurality of advertisers stored in the advertiser database on a browser screen in a switched manner switched at a predetermined time interval in accordance with a request from a client terminal; and an exclusive advertisement page display unit which displays the exclusive advertisement pages of the advertisers stored in the advertiser database on the browser screen when a certain brief advertisement image is selected.

In the above advertisement distributing server system, unlike the banner advertisement accompanying to a portal site for search, the advertisement is distributed via the exclusive advertisement site collecting only the advertising information. Hence, the advertisement plays the leading part, and the remarkable enhancement of the advertising effect can be expected.

Further, since the exclusive advertisement pages of each advertiser are stored in the database of the server system, a small company and an individual company which do not have their own homepage can easily join. In addition, the company having its own homepage can link the exclusive advertisement page with the own homepage of the company to further enable the effective use of its own homepage.

According to another aspect of the present invention, there is provided an advertisement distributing server system including: a map database which stores a plurality of map information in correspondence with area data; an advertiser database which stores advertising information which includes area data including a location of a shop of the advertiser, a brief advertisement image and an exclusive advertisement page, for a plurality of advertisers; a customer database which stores area data designated by a user; a brief advertisement image display unit which displays the brief advertisement images associated with the plurality of advertisers stored in the advertiser database and a map button on a browser screen in a switched manner switched at a predetermined time interval in accordance with are quest from a client terminal; a map display unit which displays a map corresponding to the area data designated by the user making an access and an icon indicating the location of the shop of the advertiser on the map on the browser screen when the map button is selected on the browser screen; and an exclusive advertisement page display unit which displays the exclusive advertisement page of the advertiser associated with the icon on the browser screen when a specific icon on the map displayed on the browser screen is selected.

In the above advertisement distributing server system, the user can access the desired shop informationmore intuitively by using the map of the area, that the user designated, as a key.

According to still another aspect of the present invention, there is provided an advertisement distributing method performed by an advertisement distributing server system and a client terminal connected to each other via a network, the method including: a step of registering advertising information which includes advertisement contents data to be distributed, and area data and time zone data at which the advertisement is to be distributed into a database of the advertisement distributing server system; a step of receiving a designation of area data by a user; a step of recognizing an access time of the user and selecting the advertising information which suits the area data designated by the user and the access time; and a step of distributing the advertisement contents data included in the selected advertising information to the client terminal to display the advertisement contents data on the browser screen.

In the above advertisement distributing server system, the user who accessed the advertisement distributing server system can efficiently obtain, via the network, the advertising information which can be effectively used in the designated area.

It is noted that the time zone data includes data relating to date and day of week. Also, the designation of the area data by the user may be registered to the customer database from the client terminal via the network. Alternatively, the designation of the area data may be written to a predetermined form which is received by mail or fax, and the person in charge may register it to the database. Also, “the area data designated by the user making access” includes the area data that the user designated at the time of the access, and the are a data that the user designated at the time of making the member registration via the Internet or mail or fax in the past. Further, “the area data designated by the user” includes not only the area data that the user intentionally designated, but also the area data that the advertisement distributing server system determined based on the address or postcode designated by the user. Thus, in this invention, the predetermined area data are stored in the customer database in association with the user.

In addition, the “access time” in this invention is not necessarily a moment specified by time, minute or second. For example, the access time may be specified by only date, or day of week, or month, and it may be suitably set.

According to still another aspect of the present invention, in an advertisement distributing server system which communicates with a plurality of client terminals via a network, an advertisement database stores an area, a distribution period, a distribution registration date and time at which distribution of an advertisement is registered, an advertisement image and advertisement page designating data, for each of the plurality of advertisements. The display order determining unit extracts the advertisement, whose display time is within the distribution period and which is distributed to a certain area, from the plurality of advertisements stored in the advertisement database when the client terminal requested the display, and determines a display order of the advertisement images of the advertisements extracted based on the distribution registration date and time. In the request of the display, the area may be designated by the client terminal, or may be automatically set. For example, the display order is determined from the advertisement image of the newest distribution registration date ant time in an order from the new one to old one. An advertisement image producing unit links the advertisement images of the extracted advertisements with the advertisement pages designated by the advertisement page designating data stored in the advertisement database, with a predetermined time interval, in the order determined by the display order determining unit, and produces a web page to be displayed on a screen of the client terminal. In the advertisement distribution, the user accessed the advertisement distributing server system can efficiently view the advertising information effectively usable in the specified area via the network. Also, since the display order of the advertisement image is determined based on the newest distribution registration date and time, the user can enjoy the variation of the displayed contents at every time of the display request.

In the above advertisement distributing server system, the advertisement database may further store shops in association with the advertisements. Also, an area is set to each of the shops, and the display order determining unit extracts the advertisements to be distributed to the area in the advertisement database by using a shop ID indicating the shop and an advertisement ID indicating the advertisement image file as a key. Thus, the advertisement can be distributed in a business area of the shop.

Further, in the above advertisement distributing server system, the advertisement database may further store advertisers and shops in association with the advertisements. The area is set in correspondence with an advertiser, and the display order determining unit may extract the advertisement to be distributed to the area in the advertisement database by using an advertiser ID indicating the advertiser and an advertisement ID indicating an advertisement image file.

In the above advertisement distributing server system, the advertisement database may further store genre data which classifies the advertisements into a plurality of genres. The advertisement image display unit may determine the display order for each genre and displays the advertisement images of the plurality of genres simultaneously and independently of each other in a single screen. By this, the user can view a plurality of advertisement images in parallel, and can search the advertisement images of only desired genre.

In the above advertisement distributing server system, the image files of the advertisement images are registered in the advertisement database in a hierarchical file structure having the plural IDs specifying the advertisements to be distributed as directory name. By this, the image file can be immediately read out from the advertisement database at the time of display.

Preferably, the above advertisement distributing server system may further include an advertisement registering unit for registering at least the advertisement and the area to the advertisement database. Also, preferably, the advertisement page designating data is a data designating a homepage in other server.

According to still another aspect of the present invention, there is provided an advertisement distributing method performed by an advertisement server system and a client terminal connected to each other for communication, including: a step of registering an advertising information including an area, a distribution period, a distribution registration date and time at which distribution of an advertisement is registered, an advertisement image and advertisement page designating data; a step of extracting the advertisement whose display time is within the distribution period and which is distributed to a certain area from the plurality of advertisements stored in the advertisement database when the client terminal requested the display, a step of determining a display order of the advertisement images of the advertisements extracted based on the distribution registration date and time; a step of displaying the extracted advertisement images on the screen of the client terminal at a predetermined time interval in the determined displayed order; and a step of displaying the advertisement page designated by the data stored in the advertisement database on the screen of the client terminal when a specific advertisement image is selected on the screen.

Preferably, in this advertisement distributing method, in the advertisement database, the display order is determined from the advertisement image whose distribution registration date and time is newest in an order that the distribution registration date and time is new to old.

### BRIEF DESCRIPTION OF THE DRAWINGS

FIG. 1 schematically shows a whole configuration of an advertisement distributing system according to the present invention.

FIG. 2 shows a configuration of an advertisement distributing server system according to a first embodiment of the present invention.

FIG. 3 is a diagram showing a transition of major images displayed on a browser screen of a client terminal.

FIG. 4 shows an example of a brief advertisement image displaying screen.

FIG. 5 shows an example of a map display screen.

FIG. 6 shows an example of an exclusive advertisement page.

FIG. 7 shows a configuration of an advertisement distributing server system according to a second embodiment of the present invention.

FIG. 8 shows contents of various tables shown in FIG. 7, and their association.

FIG. 9 shows a directory structure of an advertisement database in the second embodiment of the present invention.

FIG. 10 shows an example of displayed screen of a homepage of an advertisement distributing site.

FIG. 11 is a flowchart of a distribution advertisement registering processing according to the second embodiment.

FIG. 12 is a flowchart of a general advertisement distributing processing.

### PREFERRED EMBODIMENT OF THE INVENTION

The preferred embodiments of the present invention will be described below in detail with reference to the attached drawings.

[Whole Configuration of Advertisement Distributing System]

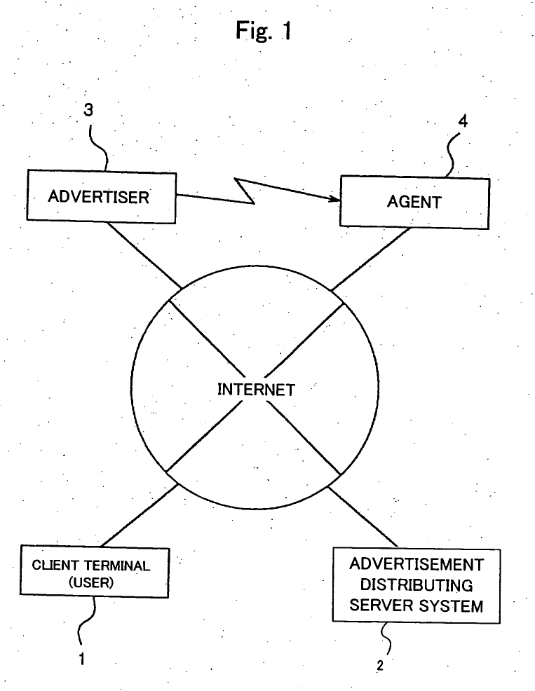

First of all, a whole configuration of an advertisement distributing system to which the present invention is applied will be described. FIG. 1 is a schematic diagram for explaining the whole of the advertisement distributing system according to the present invention by way of example.

The client terminal 1 owned by a user is connected to an advertisement distributing server system 2 via a network 5 such as the Internet, and the user (i.e., a receiver of advertisement) can obtain advertising information described later by accessing the advertisement distributing server system 2. The advertisement distributing server system 2 provides an exclusive advertising site in which only advertising information are collected. Unlike the banner advertisement collaterally displayed in a portal site for search, since the advertisement is distributed via the exclusive advertising site, the advertisement plays the leading part and the advertising effect is remarkably enhanced.

Typically, the client terminal 1 is a personal computer, a mobile terminal and a digital TV receiver, however, it is not limited to the above examples. Also, the network 5 to which this system is applied is not limited to the Internet, and includes a network using the mobile terminal of I-mode (Trademark), a local area network in a certain region and a digital broadcasting.

When using the advertisement distributing system, the user can arbitrarily select making a membership registration or using the system only once without the membership registration. However, even without the membership registration, the user is required to input (designate) only a certain area data (e.g., the postcode of the residential area) before viewing a brief advertisement image displaying screen described later, in order to obtain profitable advertising information in the area designated by the user who made access to the advertisement distributing server system 2.

When making the membership registration, the user inputs “Area Data”, “Name (nickname is available), “Mail Address”, “ID number” and else on the membership registration screen to perform registration. After completing the membership registration, when the user makes an access, the brief advertisement image display screen adapted to the area designated by the user is displayed. This can be achieved by using a technique known as Cookie, for example. Also, the designated “Area Data” can be changed on the member page now shown.

The membership registration can be performed in such a way that the user writes necessary information on an application form and the advertisement distributing server system 2 received the application form via mail or fax. In such a case, a person in charge registers the information written on the application form to the database.

[1st Embodiment]

Next, the first embodiment of the present invention will be described. In the first embodiment, the advertiser 3 registers his or her advertising information into the advertiser database in the advertisement distributing server system 2 via the agent 4. The advertising information to be registered include “Area data including shop location of the advertiser”, “Data relating to the brief advertising image (Advertisement Contents Data)”, “Data relating to the exclusive advertisement page (Advertisement Contents Data)”, “Area data where the advertiser wishes to distribute the advertisement” and “Data indicating time zone during which the advertisement is distributed”. It is noted that the data indicating the time zone is data related to the date, the day of week and the time (It is the same in the following description). The advertiser 3, who owns a network terminal device such as a personal computer, provides his or her advertising information to the agent 4 via the Internet. The advertiser 3 can provide his or her advertising information to the agent 4 by mail, FAX and other means even if the advertiser 3 does not own a network terminal.

At the network terminal of its own, the agent 4 inputs advertisement draft data including texts, still pictures, moving pictures and voices, and registers it into the database in the advertisement distributing server system 2 via the network 5. It is noted that the advertiser 3 may update the advertising information registered in the database in the advertisement distributing server system 2 directly or via the agent 4. In both cases, updating information in the database is performed via the network 5.

(Configuration of Advertisement Distributing Server System)

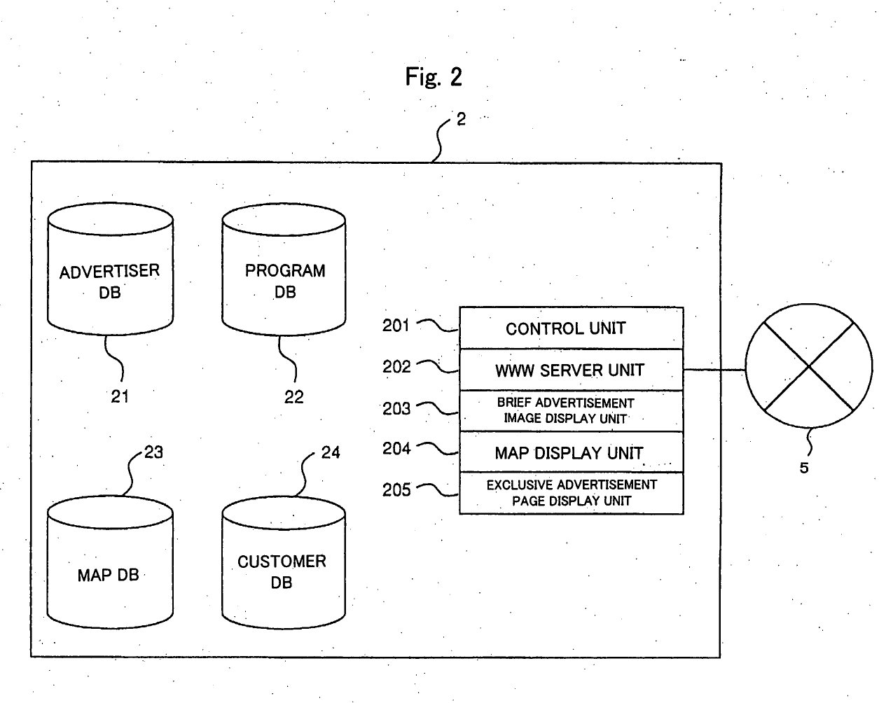

Next, the configuration of the advertisement distributing server system 2 will be described with reference to FIG. 2. The advertisement distributing server system 2 includes an advertiser database (DB) 21, a program database 22, a map database 23 and a customer database 24. A control unit 201 in the advertisement distributing server system 2 is configured by a CPU and the like, and achieves the respective functions of a WWW server unit 202, a brief advertisement image display unit. 203, a map display unit 203 and an exclusive advertisement page display unit 205 by executing various programs stored in the program database 22.

The advertiser database 21 stores, for each of a plurality of advertisers, advertising information associated with the advertisers, such as “Area data indicating the area where the shop of the advertiser is located”, “Brief advertisement image to be displayed on the brief advertisement image display screen”, “Contents of the exclusive advertisement page of the advertiser”, “Area data indicating the area where the advertiser wishes to distribute the advertising information” and “Time zone data during which the advertiser wishes to distribute the advertisement information”.

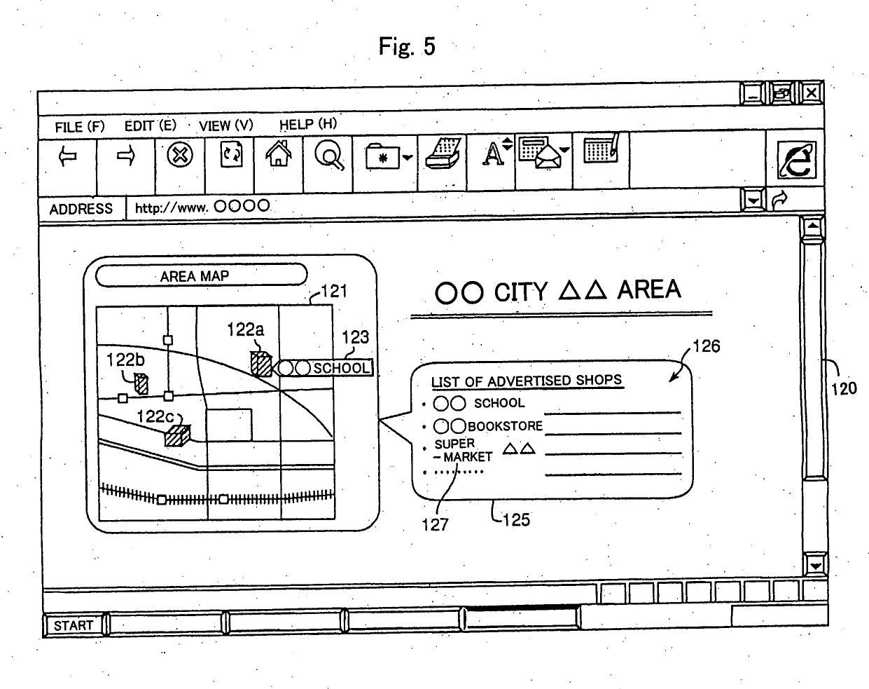

The map database 23 stores a plurality of map information in correspondence with the area data (e.g., postcode). The plurality of map information may cover whole area of Japan, or may cover only a certain area such as Kinki-area, Touhoku-area, Kyusyu-area, etc. Further, the map information may be a certain prefecture, and may be arbitrarily set. The map database 23 further stores shop display icons 122 (see. FIG. 5) to be displayed on the map. It is preferred that the shop display icons 122 are set in a manner classified by the type or genre of business.

The customer database 24 stores customer data such as the area data designated by the registered members, the nickname, the mail address and the like, and also temporarily stores the area data input by the user who made access only once without membership registration.

(Description of Browser Screen)

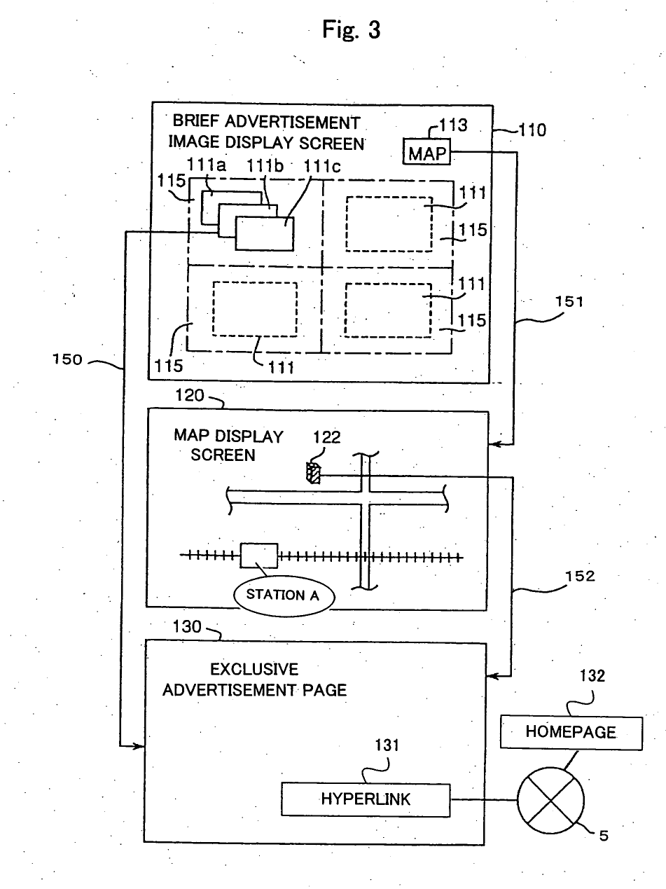

FIG. 3 schematically shows the transition of the major display screens displayed on the browser screen on the client terminal 1 of the user in the present invention. It is noted that the browser screen is displayed on the display unit of the client terminal 1 by executing the browser software on the client terminal 1, and the web browser is used in a case that the network 5 is the Internet.

When the user accesses the advertisement distributing server system 2 from the client terminal 1 and completes predetermined procedure such as the membership registration or inputting the area data, the brief advertisement image display screen 110 shown in FIG. 3 is displayed on the browser screen. The user can view the exclusive advertisement page 130 of a certain advertiser, by making a click on one of the listed brief advertisement images 111 or by way of the map display screen 120 which is displayed when the user makes a click on the MAP button 113 displayed on the brief advertisement image display screen 110. If the advertiser owns other homepage in other server, the user can jump to the homepage 132 via the network 5 such as the Internet by routing the hyperlink 131.

The “area data” in the present invention may be “postcode”, “regions such as Kanto, Kansai, Kyusyu, which are divided by a certain rule”, “prefecture”, “city or village”, “area around [symbol] [symbol] station”. Of course, other kind of data may be arbitrarily set.

By inputting the area data corresponding to his or her residential area, the user can obtain the advertising information advantageously usable in that residential area. In addition, when the user makes a trip to a distant area, he or she can obtain the advertising information advantageously usable in the area by inputting the area data of the area of the trip. Further, by using a plurality of area data, the advertising information of a certain item in different areas can be compared.

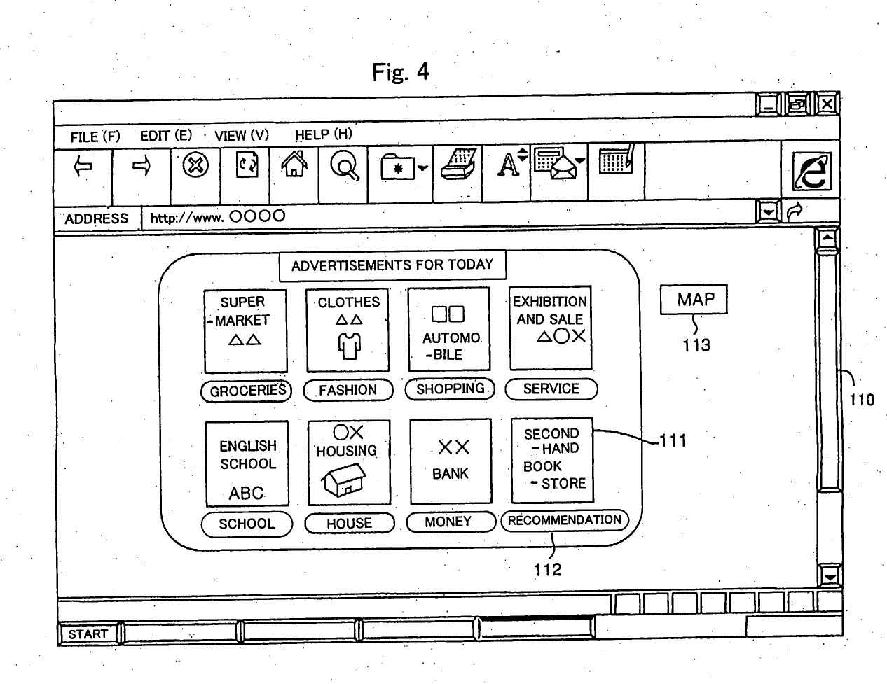

Next, the description will be given of the processing executed when the user views the exclusive advertisement page 130 directly from the brief advertisement image display screen 110 (corresponding to the arrow 150 in FIG. 3). FIG. 4 shows a specific example of the brief advertisement image displaying screen 110. In the example of FIG. 4, the brief advertisement images 111 for a plurality of companies (advertisers) are displayed in the form of a list or table. This listed display selectively shows only the brief advertisement images for the advertisers who wish to distribute the advertisement in the area, based on the area data that the user inputs or designates at the time of membership registration or access.

Specifically, the following control is performed. The control unit 201 in the advertisement distributing server system 2 recognizes the time of access made by the user by using the clock function. Then, the control unit 201 compares “the area data and the time zone data designated by the advertiser” with “the area data designated by the user and the access time “to selectively display the brief advertisement images 111 associated with the advertisers for which the compared data are matched. Here, the “access time” is not necessarily specified by the time, minute and second. In some cases, the access time may be specified only by “date”, “day of week”, “month” or else in various manners. If the advertiser does not designate the time zone, only the match or mismatch of the area data is determined.

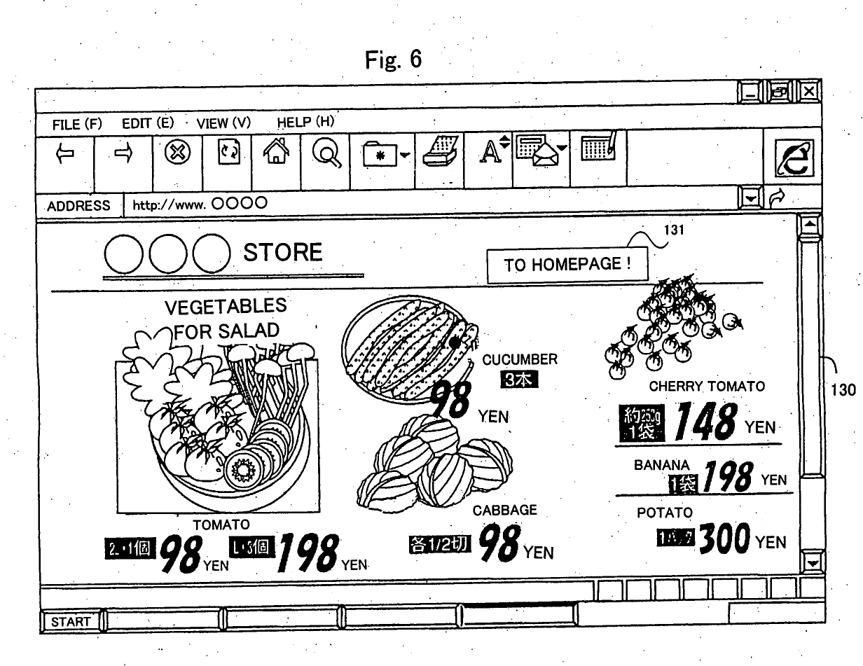

The brief advertisement image 111 briefly introduces the advertisement contents of the advertiser. The user can view the exclusive advertisement page 130 for the advertiser, shown in FIG. 6 as an example, by making a click on the brief advertisement image 111 displayed on the browser screen, thereby to obtain specific advertising information associated to the advertiser. If the advertiser owns other homepage 132 in other web server, the user can jump to the homepage 132 from the exclusive advertisement page 130 by making a click on the button 131. The brief advertisement image 111 may include brief advertising information for the purpose of introduction of the advertiser. Also, the brief advertisement image 111 may be designed not to display the specific advertiser, so that the user can recognize the advertiser for the first time when he sees the exclusive advertisement page 130.

In the brief advertisement image display screen 110, it is preferred that the matrix display shown in FIG. 3 and FIG. 4 is performed. The 2×2 matrix display is used in the example of FIG. 3, and the 4×2 matrix display is used in the example of FIG. 4. These can be selected suitably. In the 2×2 matrix display shown in FIG. 3, the brief advertisement images 111 can be displayed by using four frame areas 115. Similarly, the number of frame areas 115 is eight in the 4×2 matrix display used in FIG. 4.

It is preferred that the frame areas 115 forming the matrix are classified by the genre to display a plurality of brief advertisement images 111. Namely, as shown in FIG. 4, the genre display areas 112 showing the genre are displayed under the brief advertisement images 111. In addition, as shown in FIG. 3, in each frame area 115, a plurality of brief advertisement images 111a, 111b, 1111c are cyclically and repeatedly displayed in a switched manner, with a predetermined time interval. In FIG. 3., for the sake of illustration, three brief advertisement images 111a, 11b, 111c are shown at the same time. However, in an actual browser screen, each brief advertisement image 111 is displayed in a switched manner with the certain time interval. By such a display manner, many brief advertisement images can be efficiently displayed on the browser screen. The form including only one frame area 115 may be employed, and a plurality of frame areas 115 may be displayed, not in the matrix arrangement, but in a random arrangement.

Preferably, the program is designed such that, when the genre display area 112 on the browser screen is clicked, the plurality of brief advertisement images cyclically displayed in the corresponding frame area in the switched manner are all displayed as a list. By making a click on the brief advertisement image displayed in that way, the user can also proceed to the exclusive advertisement page 130 shown in FIG. 6. The number of the brief advertisement images selectively displayed in the switched manner within a single frame area may be arbitrarily determined, and is not limited to the three kinds of brief advertisement images 111a, 111b and 111c in the above example.

Next, the description will be given of the processing executed when the user views the exclusive advertisement page 130 from the brief advertisement image display screen 110 by way of the map display screen 120 (corresponding to the arrows 151 and 152 in FIG. 3).

As shown in FIG. 3, the MAP button 113 is also displayed on the brief advertisement image display screen 110. When the user clicks the MAP button 113, the map display screen 120 shown in FIG. 5 by way of example is displayed on the browser screen. In this map display screen 120, based on the area data inputted by the user, the map 121 corresponding to the map data is read out from the map database 23 and displayed.

When the shop of the advertiser exists on the map 121 displayed on the map display screen 120, predetermined icons (“foldout” mark) 122a, 122b and 122c are displayed at the position of the shop. When the user positions the cursor on a certain icon (e.g., 122a) on the browser screen, the name of the participating company 123 is displayed. Also, in addition to the map 121, a list display area 125 which shows a list of the advertisers whose shops exist in the area may be provided. Preferably, the icons are different between the types or genres of the business. In the list display area 125, the names of the participating companies 127 are displayed in a list, and brief advertising sentences are displayed.

The user can view the exclusive advertisement page 130 shown in FIG. 6 by making a click on the icons on the map or the name of companies in the displayed list. In this case, the user can access the desired shop information more intuitively by taking advantage of the map of the area that he or she has designated.

While omitted from the illustration, it is preferred that certain items are picked up in advance to produce a page which displays the prices of those items in comparison for the plurality of advertisers who provides the items thus picked up. For example, when “a headphone stereo of [symbol] [symbol] company” is picked up, the prices of the headphone stereo sold by-a plurality of home-electronics shops are listed in a table and displayed. Such a page serves as an extremely profitable information source for the user who wants to buy a certain item. This can be achieved by storing the price information of the items handled by the advertisers, for each advertiser, in the advertiser database 21 shown in FIG. 2, and by retrieving the information of the advertisers for a certain item to make the table and display it. It is noted that the items to be picked up may be determined by the advertisement distributing server system 2 or by the user.

[2nd Embodiment]

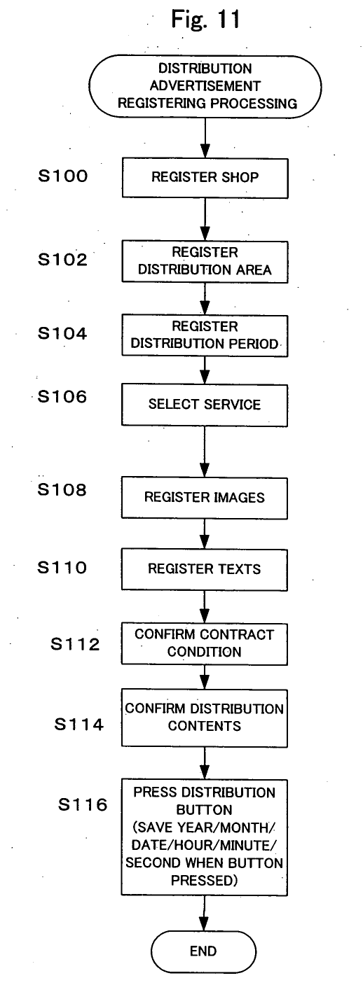

Next, the second embodiment of the present invention will be described. In this embodiment, the advertiser 3 calls out the advertiser management screen of the advertisement distributing server system 2 at the network terminal of his or her own, inputs advertisement draft data including texts, still pictures, moving pictures and voices, and registers his or her advertising information into the database in the advertisement distributing server system 2 (see. FIG. 11). The advertisement is prepared and distributed for each shop. As described later, the advertising information to be registered includes the advertiser, the shop, the brief advertisement image file, the distribution registration date and time, the distribution period, the distribution area, the genre and the like, and the advertisement is specified by the advertiser ID, the shop ID and the advertisement ID.

In this embodiment, the designation of the shop includes the designation of the distribution area and the genre at the same time. The “distribution area” is an area where the advertiser wishes to distribute the advertisement. The “distribution period” is a time period during which the advertiser wishes to distribute the advertisement, and includes data specified by date, day of week and time. 0The advertiser 3 may ask the registration of the advertising information to the agent 4.

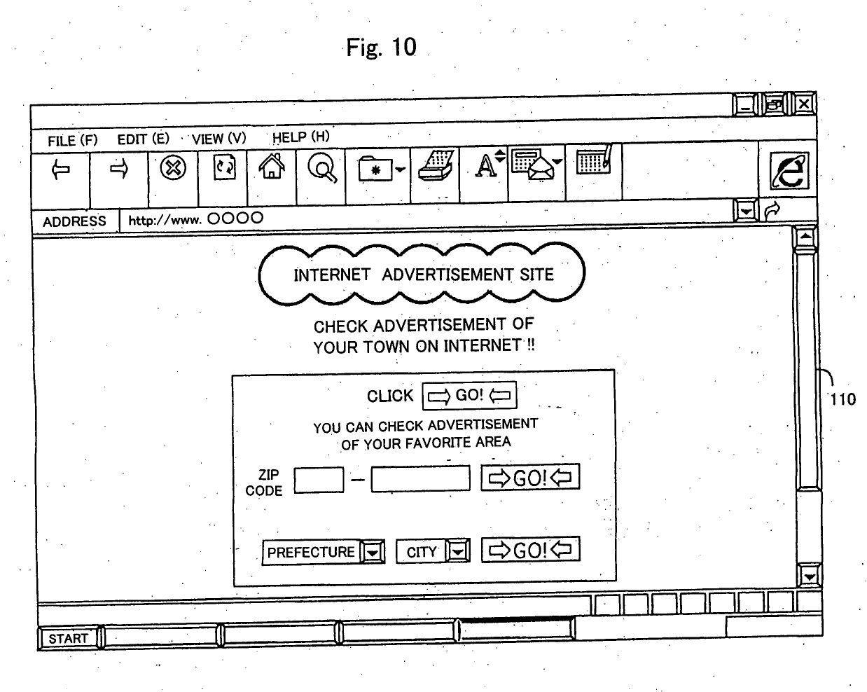

The user who accessed the advertisement distributing server system 2 first selects the distribution area (hereinafter also referred to as simply “area”) for which the user wants to see the advertisement. The “area” is designated by the user by inputting the postcode or address (prefecture and city name, see the browser screen shown in FIG. 10). However, if the position of the user terminal 1 is automatically recognized by the PHS position information providing service or by the position determining service by using GPS, the area may be automatically set by the position obtained by the automatic recognition. Further, as described later, if the user is the member of the advertisement distributing server system 2, the area designated by the user at the time of the membership registration may be set at the next access.

In the advertisement distributing server system 2, the advertisement is displayed for each shop (advertiser). In such an advertisement, the advertisement is effective in the area including the location of the shop. The advertiser sets the distribution period and the distribution area in consideration of the advertising effect. By designating the area in the homepage, the user can view the advertisement distributed on that day in that area. The advertisement distributed on one day before (yesterday) and the advertisement to be distributed on the next day (tomorrow) may be displayed.

In order to use the advertisement distributing server system, the user can freely select making the membership registration or using the system only once without making the membership registration. However, even if the user does not make the membership registration, the user is required to input (designate) a certain area data (e.g., the postcode of his or her residential area). This is because, in this embodiment, the advertising information is displayed on the screen for each area designated by the user.

When the user designates the area on the homepage (or has designated the area at the time of the membership registration) and requests the display, the advertisement distributed on that day in that area is displayed on the brief advertisement image display screen 110 shown in FIGS. 3 and 4 by way of example, in the similar manner as the first embodiment. In the brief advertisement image display screen 110, the brief advertisement image 111 is displayed for each of the plural genres. In the example shown in FIG. 4, eight frame areas of 2×4 are displayed within one screen, and the genres corresponding to the respective frame areas are eight, including super/food, fashion, shopping, living and so on. The brief advertisement image 111 is displayed in each of the frame areas, and the genre display areas 112 indicating the genre are displayed below them. In this embodiment, the genre and the distribution area are designated for each shop, and the designation of the shop includes the designation of the genre and the distribution area at the same time.

The word “brief” in the brief advertisement image 111 is used to discriminate it from the exclusive advertisement page. The brief advertisement image 111 is generally a smaller image than that of the exclusive advertisement page and its advertising contents is briefer. It is preferred that the brief advertisement image is to emphasize the name of the advertiser to enhance the eye-catch effect, however, other suitable image may be used. For example, the brief advertisement image may include the short sentences of the shop name and the service contents, the mark of the shop and small images of the items. A service such as a special sale, specifying the date and time, may be advertised, and the sentences attracting the customers such as “Only today”, “Special service”, “New Appearance” may be included. Also, in the brief advertisement image, brief advertising information may be included for the purpose of the introduction of the advertiser. The brief advertisement image may be designed to enable the advertiser to recognize the advertiser for the first time when the user sees the exclusive advertisement page, without including the display of the specific advertiser.

In the brief advertisement image display screen 110, the brief advertisement image 111 is displayed with motion. In the example of FIG. 3, in the respective frame areas, a plurality of brief advertisement images of the corresponding genre, being distributed in the designated area, are displayed in order at the same display position with a predetermined time interval (e.g., 3 seconds). When the brief advertisement images are displayed from the first one to the last one, the display is repeated from the first one. The user can enjoy viewing various brief advertisement images displayed one after another with the predetermined time interval.

For a general advertisement, the display order of the brief advertisement images 111 is determined, for each genre, from the advertisements being distributed on that data in that area, in accordance with the predetermined rule, which is determined in advance based on the distribution registration date and time. In this embodiment, the brief advertisement images are displayed in an order from the one having the newest distribution registration date and time. In this case, the image registered at latest is displayed at the first. Other than the time of adding the advertisement, the display order is also changed when the advertisement distribution is ended by the lapse of the distribution time period or by the operation by the advertiser. Thus, the display order is changed in accordance with the distribution situation of the advertisement. The display order may be determined by the repetitive automatic reading of a unit time (e.g., 10 minutes). Also, for the display order according to the distribution registration date and time, the display order may be determined randomly for the plural advertisements registered within a predetermined time (e.g., 1 hour). Accordingly, in the present system, the display order may be changed every time the user makes an access, and hence the user can enjoy the change of the display of the brief advertisement images. According to the kind of the service, the display order should be fixed. In this embodiment, the display order is varied dependently upon the distribution registration date and time, only for the general advertisement.

The brief advertisement image 111 is linked with the exclusive advertisement page 130. When finding an attractive and interesting brief advertisement image among the brief advertisement images actively displayed, the user clicks it. In response to the click, the exclusive advertisement image which displays only the information associated with the advertisement on the whole screen is displayed, and the user can know the detailed advertisement contents. Since the exclusive advertisement page of the respective advertisers can be stored in the advertisement database in the advertisement distributing server system 2, a small company or an individual company having no own homepage can readily join. A company having its own homepage can make advantageous use of the own homepage by linking the exclusive advertisement page with the own homepage. It is noted that the membership registration can be performed in the same manner as the first embodiment.

(Configuration of Advertisement Server System)

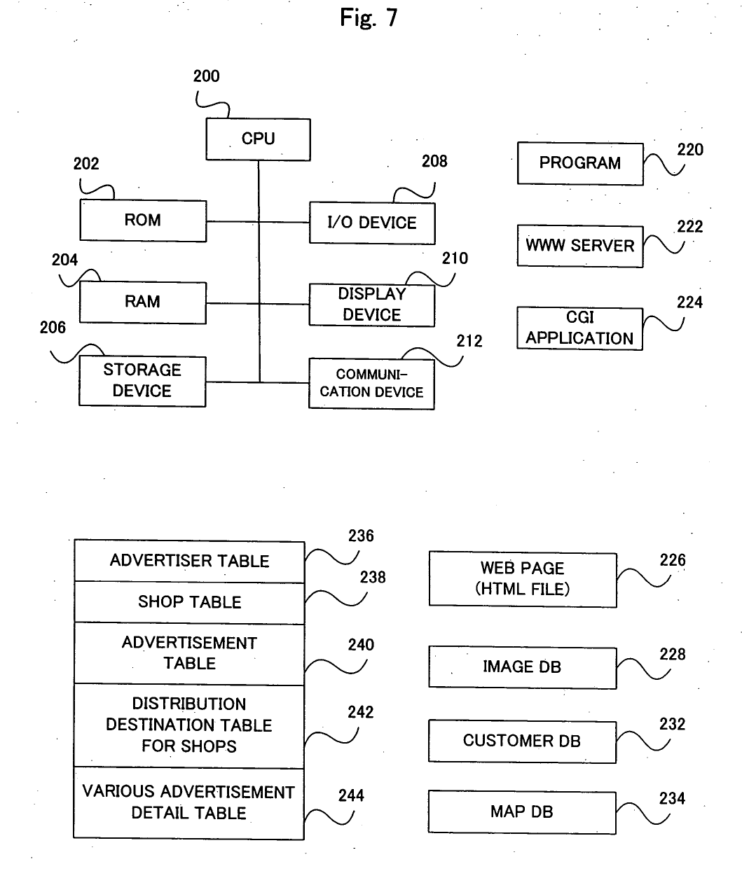

FIG. 7 shows the configuration of the advertisement distributing server system 2 according to this embodiment. The advertisement distributing server system 2 is a computer including a CPU 200, and the CPU 200 is connected to a ROM 202, a RAM 204, a storage device 206 such as a hard disc, an input/output device 208 such as a keyboard and a mouse, a display device 210 such as a CRT, and a communication device 212 to establish the connection with the network 5 such as the Internet. The storage medium (such as a hard disc) of the storage device 206 stores CGI applications 224 and web pages (HTML files) 226, in addition to various programs such as OS. Also, the storage device 206 functions as the advertisement database, which stores various data for the advertisement distribution, i.e., an image database 228, a customer database 232, a map database 234, an advertiser table 236, a shop table 238, an advertisement table 240, a distribution destination table for shops 242 and various advertisement detail table 244 (general advertisement table, coupon advertisement table, delivery advertisement table, present advertisement table, sample & monitor advertisement table and so on). The customer database 232 stores the customer data such as the area data designated by the registered member, the name and the mail address, and also temporarily stores the area data input by the user who accessed only once without the membership registration.

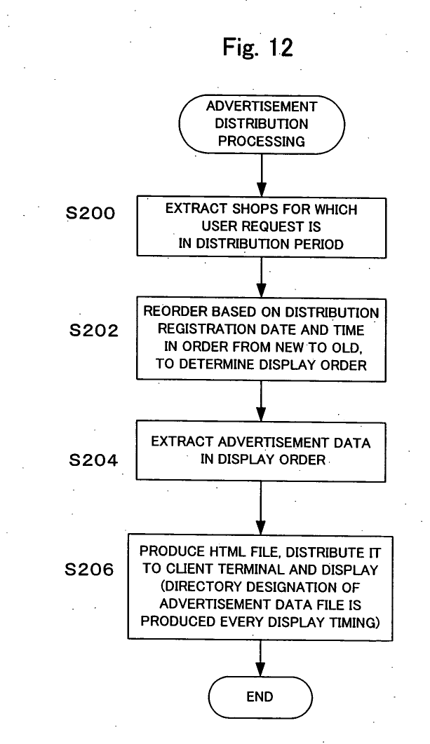

The web page 226 includes the brief advertisement image display page, the exclusive advertisement page display page and the map display page. The WWW server 222 includes the CGI (Common Gateway Interface), and starts up the CGI application 224. Namely, when the command is sent from the web browser of-the user terminal, the WWW server 222 calls the CGI application 224. The CGI application 224 receives the data and accesses the associated database to produce HTML data. Thus, the brief advertisement image display page is produced every time when the display is requested, and reflects the latest distribution status (see. FIG. 12). The WWW server 222 returns the result to the web browser.

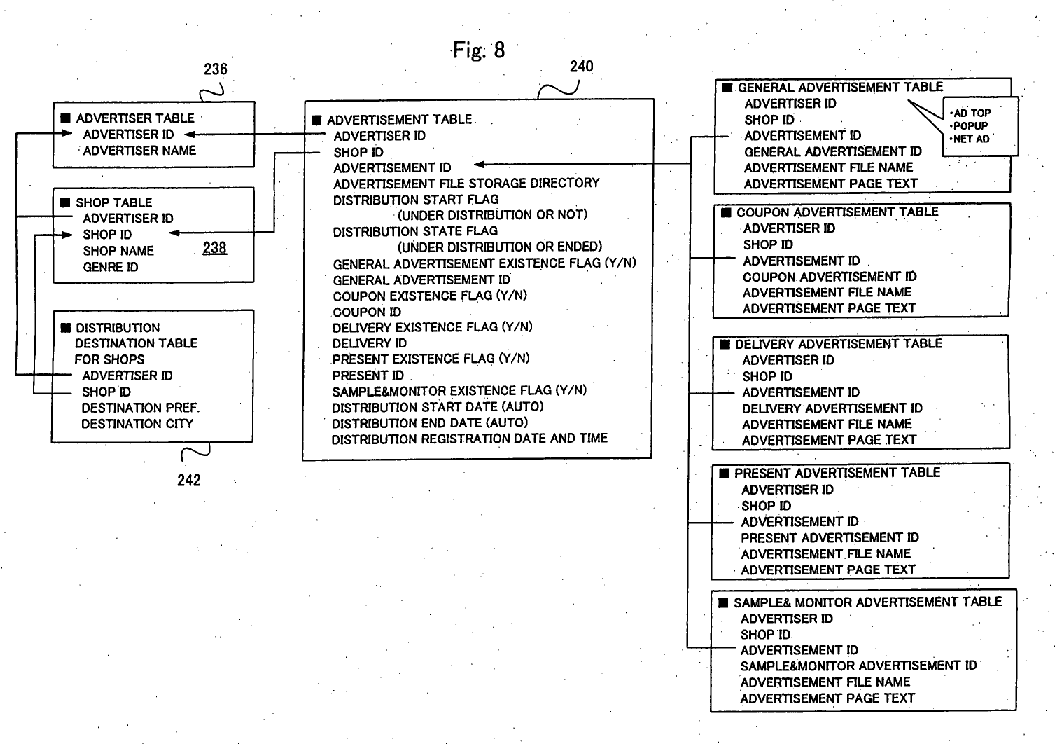

FIG. 8 shows the association between the above-mentioned tables by various IDs. In the advertiser table 236, a unique advertiser ID is allocated to each advertiser. In the shop table 238, a shop ID is automatically allocated to each advertiser. In the advertisement table 240, an advertisement ID is automatically allocated to each shop. When the shop is specified by the advertiser ID and the shop ID, the distribution area of the advertisement associated with the shop is recognized by referring to the distribution destination table for shops 242. In this way, the advertisement is specified by those three IDs, and the various table for the advertisement are associated with each other by the three IDs (i.e., the advertiser ID, the shop ID and the advertisement ID).

Each table will be described in more detail. As shown in FIG. 8, the advertiser table 236 includes the advertiser ID and the advertiser name. The shop table 238 includes the advertiser ID, the shop ID, the shop name and the genre ID. The distribution destination table for shops 242 includes the advertiser ID, the shop ID and the distribution destination area data (prefecture and city of the distribution destination). The advertisement table 240 includes the advertiser ID, the shop ID, the advertisement. ID, the advertisement file storage directory, the general advertisement ID, various flags, the distribution start flag (for checking whether the distribution is going on or not), the distribution state flag (for checking whether the distribution is going on or ended), the start date of the distribution period (automatic process), the end date of the distribution period (automatic process) and the distribution registration date and time. Further, the general advertisement table includes the advertiser ID, the shop ID, the advertisement ID, the brief advertisement image file (advertisement file) name and the advertisement page text.

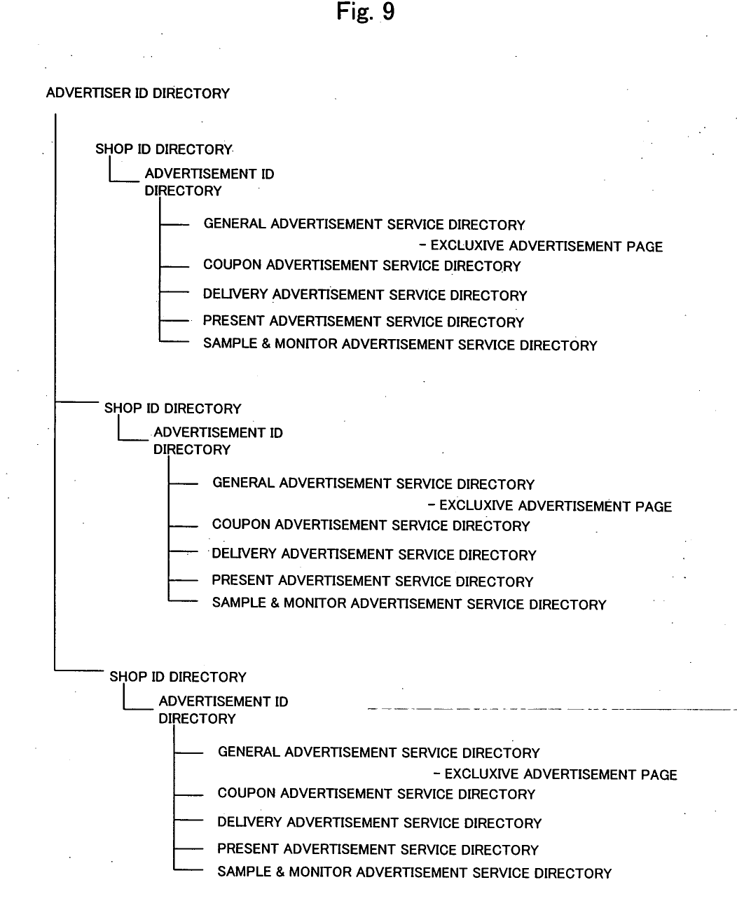

FIG. 9 shows the directory structure in the image database 228 which stores the image files of the brief advertisement images. In the image database 228, image files are stored in the hierarchies of an advertisement ID directory, a shop ID directory and an advertisement ID directory. In the lowest hierarchy, there are provided a general advertisement service directory, a coupon advertisement service directory, a delivery advertisement service directory, a present advertisement service directory and a sample & monitor advertisement service directory for various services. The general advertisement service directory includes exclusive advertisement page information. The advertisement data is specified by three IDs, i.e., the advertiser ID, the shop ID and the advertisement ID, and those three IDs are used as the directory name to configure the hierarchy of the file structure to store the image files.

In this embodiment, the advertisement data is specified by the three IDs, i.e., the advertiser ID, the shop ID and the advertisement ID, and the genre and the distribution area are specified by the shop ID. However, it is not always necessary to use all of those three IDs. In general, the distribution area of the advertisement may be stored in direct or indirect association with the advertisement data. Namely, the distribution area information indicating the areas to which the advertisement is distributed for each of the plurality of advertisements is stored in the advertisement database. When the client terminal requests the display, the advertisement within the distribution period and distribution area to be displayed is extracted from the plurality of advertisements stored in the advertisement database and its display order is determined.

The advertiser may wants to sell items for limited sales area. In order to distribute the advertisement to the objective area in such a case, the advertisement may be specified by the advertiser ID and the distribution area may be associated with the advertiser. In that case, by comparing the table structure with FIG. 8, the shop table and the shop ID do not exist, and the advertiser is associated with the distribution area in the distribution destination table. In addition, by comparing the directory structure in the advertisement database with FIG. 9, the shop ID directory does not exist in the hierarchy structure. At the time of display, the advertisement to be distributed to the distribution area are extracted by using the advertiser ID specifying the advertiser and the advertisement ID specifying the advertisement image file as the key. Such a data structure is suitable in advertising the sales at the location, such as an automatic vending machine, which cannot be called as a shop.

Also, in the above embodiment, in the advertisement database, the distribution area indicating the area where the advertisement is to be distributed is registered for each advertisement. However, the area to be registered for each advertisement may be registered, not as the area in which the advertiser wishes to distribute the advertisement, but as the area with which the advertisement is associated in a certain meaning. In that case, when the user designates the area and requests the display, the brief advertisement image screen associated with the area is displayed.

(Browser Screen)

When the user accesses the advertisement distributing server system 2 from the terminal 1, the homepage shown in FIG. 10 is displayed. When the user inputs the area data and presses the button “GO”, the next screen (the brief advertisement image display screen 110) is displayed. As described above, the area data may be input as the postcode or the area data. (It is noted that the button to move to the membership registration screen is omitted in FIG. 10.)

In this embodiment, the major display screen displayed on the browser screen of the client terminal 1 of the user is the same as the first embodiment. Namely, when the area is designated in the screen shown in FIG. 10, the brief advertisement image 110 (see. FIGS. 3 and 4) for the general advertisement service is displayed. Here, only the brief advertisement images 111 of the advertiser who wishes to distribute the advertisement in the area indicated by the area data are displayed. By clicking one of the brief advertisement images 111, the user can view the exclusive advertisement page 130 of the advertiser. If the advertiser owns other homepage in other server, the user can jump to the homepage 226 by way of the Internet by following the hyperlink 131.

In the brief advertisement display screen 110, the brief advertisement images of a plurality of genres are displayed at the same time. The display manner may be suitably selected. The matrix display as shown in FIGS. 3 and 4 is desirable. In the 2×2 matrix display shown in FIG. 3, the brief advertisement images 111 can be displayed by using four frame areas 115. Similarly, the number of frame areas 115 is eight in the 4×2 matrix display used in FIG. 4. The frame area 115 may be only one. Also, the plural frame areas may be arranged, not in the form of the matrix, but at random. While the positions of the frame areas are fixed in this embodiment, the positions may be moved. For example, the positions of the frame areas may be moved in spiral for each of the brief advertisement images 111.

In each frame area of the advertisement image display screen 110, a plurality of brief advertisement images 111 belonging to the genre corresponding to that frame area are displayed in order. In each frame area, as schematically shown in FIG. 3, a plurality of brief advertisement images 111a, 111b, 111c belonging to the genre are cyclically and repeatedly displayed in a switched manner, with a predetermined time interval (e.g., 3 seconds). If the display is started after all of the brief advertisement images 111 to be displayed are loaded, the start of the display is delayed. Therefore, the images are loaded one by one at every time of the display. If the whole of the brief advertisement image cannot be developed when a predetermined time interval has elapsed, that image is not displayed and kept in the cache, and one of the images already loaded (e.g., the first image) is displayed, and reading the next image is started. The number of the brief advertisement images selectively displayed in a single frame area in the switched manner may be arbitrarily determined, and is not limited to the three kinds of brief advertisement images 111a, 111b and 111c in the above example of FIG. 3. In FIG. 3, the three brief advertisement images 111a, 11b and 111c are displayed at the same time for the sake of illustration. In the actual browser screen, in each frame area, a plurality of brief advertisement images are displayed in the switched manner, in order, with a predetermined time interval. By employing such a display manner, many brief advertisement images can be efficiently displayed on the browser screen. In addition, the user can enjoy the brief advertisement images cyclically displayed with a predetermined time interval, and can proceed to more detailed information (the exclusive advertisement page 130 shown in FIG. 6) by clicking the advertisement of interest.

Further, preferably, when the advertisement genre displayed area 112 near one frame area is clicked on the browser screen, a list display (text version) of the plurality of brief advertisement images cyclically displayed in the switched manner in the frame area is shown. By clicking the advertisement in the listed display, the user can proceed to the exclusive advertisement page 130 shown in FIG. 6.

Next, viewing the exclusive advertisement page 130 from the brief advertisement image screen 110 will be described. The brief advertisement image 111 is to briefly introduce the advertisement contents of the advertiser. The user can view the exclusive advertisement page 130 (see. FIG. 6) by clicking the brief advertisement image 111 displayed on the browser screen, and thereby obtains detailed advertising information associated with the advertiser. Further, if the advertiser has his or her own homepage 132 in other web server, the user can jump to the homepage 132 from the exclusive advertisement page 130.

The advertiser 3 registers the advertisement to be distributed in the advertisement distributing server system 2. FIG. 11 is a flowchart of a CGI application of the distribution advertisement registering processing. The advertiser 3 displays the advertiser management screen (not shown) of the advertisement distributing server system 2 on the web browser on his or her own terminal, and starts the registration. First, the advertiser registers the shop (genre) associated with the advertisement to be distributed (S100). Here, the registration of the shop is performed for one or more shops, and the genre is set for the shops at this time. The genre of the shop is the genre of the advertisement.

Next, the advertiser 3 registers the distribution area (S102). Here, the distribution area is registered for each shop. The registered distribution area is the distribution area of the advertisement. The distribution area is associated with the “postcode to be viewed” or “selection of prefecture and city”. Next, the advertiser 3 registers the distribution period (S104). Here, the distribution period is registered for each shop. The advertisement data is distributed during the distribution period thus registered, and the distribution is automatically ended when the distribution period is ended. The advertiser 3 can arbitrarily change, add and delete the advertisement data during the distribution period. However, in that case, the distribution should be paused.

Next, the advertiser 3 registers the advertisement for each shop. At that time, the advertiser 3 first selects the service (S106). Specifically, the advertiser 3 selects any one of the services such as the general advertisement, the present, the sample & monitor, the coupon and the delivery. Next, the advertiser 3 registers the brief advertisement image file (image/HTML file) (S108). Here, the advertiser 3 uploads the necessary image file to the advertisement distributing server system 2, and stores it in the corresponding directory in the image database 228. Next, the advertiser 3 uploads the advertisement text information to the advertisement distributing server system 2, and registers it in the table (S110). The advertisement text information is information displayed as the popup text, and the text advertisement is popped up when it is clicked. Thus, the advertising information of the advertiser 3 is registered in the advertisement distributing server system 2.

Thereafter, the advertisement distributing server system 2 distributes the advertisement for each shop. At that time, the advertiser 3 confirms the contract condition (advertiser information/shop information) and the distribution condition (contents of the advertisement) (S114), and finally presses down the distribution button (S116). By this, the advertisement is registered, and the distribution registration date and time (i.e., year, date, time, minute and second at the time the distribution button is pressed) is saved in the advertisement table 240. For the general advertisement, the display order of the advertisement images to be displayed is determined based on the distribution registration date and time.

Next, the description will be given of the advertisement distribution processing executed by the advertisement distributing server system 2. On the homepage screen (FIG. 10) of the web browser in the user terminal 1, when the area is designated as one of the “postcode to be viewed” and the “selection of prefecture and city”, the advertisement of the area is distributed. The user can arbitrarily select and view the distributed advertisement data. Here, the determination of the display order of the advertisement data and the extraction of the data are executed in the following way.

FIG. 12 is a flowchart of the CGI application of the advertisement distribution processing. The display order of the advertisement data is determined by a program processing immediately before the user specifies the area for viewing and displays the advertisement. When the user designates the distribution area and requests the display, this processing is started. It is noted that, when the user requests the display, the genre and the distribution area of the advertisement has already been set.

First, the shops for which the day the user requests the display is within the distribution period are extracted (S200) Specifically, the advertisement distributing server system 2 searches for and extracts the advertisement corresponding to the selected area in consideration of the distribution period. Next, the advertisement distributing server system 2 checks whether or not the extracted shops have the general advertisement, and extracts “the genre of the shop”, “the distribution area”, “the distribution period”, “the distribution registration date and time” from the advertisement database for the shop having the general advertisement. The advertisement data at that time is extracted by using “the genre of the shop”, “the distribution area”, “the distribution period”, and “the distribution registration date and time” as the key.

Next, if the object of the distribution includes the general advertisement, the advertisement distributing server system 2 reorders the advertisements in the order from the new one based on the distribution registration date and time to determine the display order (S202). Thus, the distribution area of the shop is confirmed, and the display order is reordered by the order of the distribution registration date and time, in the genre of the shop, with the latest distribution registration date and time placed at the head position. In each genre (frame area), the brief advertisement images are displayed in the order thus determined. If displayed in the order of the distribution registration date and time, the brief advertisement image to be displayed first in the frame area is the same image on that day. However, by displaying in the order of the distribution registration date and time from the latest one, the display order of the brief advertisement image at the corresponding frame area changes every time the distribution is registered.

When the display order is determined for the advertisement data meeting the extraction condition, then the advertisement distributing server system 2 extracts the advertisement data from the database and the directory in the display order (S204). At this time, “the advertiser ID”, “the shop ID” and the “advertisement ID” are used as the key. The directory is referred to in the advertisement table.

Next, the advertisement distributing server system 2 produces the web page (HTML file) based on the display order and the extracted advertisement data, and distributes it to the client terminal 1 as the web page, which is then displayed (S206). The display of the brief advertisement images on the browser screen with the predetermined interval is controlled by the applet of JavaScript described in the HTML file. Thus, the path designation of the advertisement image data on the HTML file is produced at every timing of the display request. In this way, the newest page in the selected area is displayed, and the general advertisement data registered by the advertiser are displayed in the order. While there are information designations (paths) such as “text advertisement” or “file advertisement (image)” on the HTML file, the text advertisement designates the table and the file advertisement designates the directory in the image database 228. Thereby, the HTML file is produced and displayed as the web page.

By employing the hierarchical directory structure as shown in FIG. 9, the image file to be displayed can be immediately specified and rapidly displayed at the time of displaying the advertisement data. At the time of displaying the brief advertisement image, one image file is loaded from the image database 228 at one timing according to the display order. While the advertisement data is specified by the advertiser ID, the shop ID and the advertisement ID in this embodiment, the command instructing the display in the HTML file includes “http://www.advertisement.com/advertiserID/shopID/advertisementID/general advertisement service/image file name”, which indicates the URL of the image file. The “www.advertisement.com” indicates the site of the advertisement distributing server system 2. Therefore, in this URL, a plurality of identification numbers (ID) used to determine the display order is included in the path to the image file. Thus, the path to the image file to be displayed can be immediately determined. Namely, the image file storing the brief advertisement image file designated by the advertiser ID, the shop ID and the advertisement ID is immediately searched for and read out in the image database 228. In this way, reading out the image file can be efficiently executed.

Next, viewing the exclusive advertisement page 130 via the map display screen 120 will be described. In the brief advertisement image display screen 110, the MAP button 113 is displayed (see. FIGS. 3 and 4). By clicking the MAP button 113 displayed on the brief advertisement image display screen 110, the user can view the exclusive advertisement page 130 of a particular advertiser via the map display screen 120 displayed. Namely, when the user clicks the MAP button 113, the map display screen 120 shown in FIG. 5 is displayed on the browser screen. In the map display screen 120, based on the area data input by the user, the map 121 corresponding to the area is read out from the map database 234.

The map database 234 stores a plurality of map information in correspondence with the area data (e.g., postcode). The plurality of map information may cover whole area of Japan, or may cover only a certain area such as Kinki-area, Touhoku-area, Kyusyu-area, etc. Further, the map information may be a certain prefecture, and may be arbitrarily set. The map database 234 further stores shop display icons 122 (see. FIG. 5). It is preferred that the shop display icons 122 are set in a manner classified by the type or genre of business.

When the shop of the advertiser exists on the map 121 displayed on the map display screen 120, predetermined icons 122a, 122b and l22c (“foldout” mark) are displayed at the position of the shop. When the user positions the cursor on a certain icon (e.g., 122a) on the browser screen, the name of the participating company 123 is displayed. Also, in addition to the map 121, a list display area 125 which shows a list of the advertisers whose shops exist in the area may be provided. Preferably, the icons are different between the types or genres of the business. In the list display area 125, the names of the participating companies 127 are displayed in a list, and brief advertising sentences are displayed.

The user can view the exclusive advertisement page 130 shown in FIG. 6 by making a click on the icons on the map or the name of companies in the displayed list. In this case, the user can access the desired shop information more intuitively by using the map of the area, that he or she has designated, as a key.

### INDUSTRIAL APPLICABILITY

The present invention provides a way to provide advertising information to the user by utilizing a network such as the Internet, and is utilizable in an information distribution or advertisement utilizing the network such as the Internet.

1. An advertisement distributing server system comprising:
an advertiser database which stores advertising information including brief advertisement images and exclusive advertisement pages for a plurality of advertisers;
a brief advertisement image display unit which displays the brief advertisement images associated with the plurality of advertisers stored in the advertiser database on a browser screen of the terminal in a switched manner switched at a predetermined time interval in accordance with a request from a client terminal; and
an exclusive advertisement page display unit which displays the exclusive advertisement page of the advertiser stored in the advertiser database on the browser screen when a certain brief advertisement image is selected.

2. The advertisement distributing server system according to claim 1, further comprising a customer database which stores area data designated by a user,
wherein the advertiser database stores the advertising information in association with an area and a time zone at which the advertiser wishes to distribute advertisement, and
wherein the brief advertisement image display unit displays the brief advertisement image on the browser screen for the advertiser which suits area data designated by the user making access and a time of the access.

3. The advertisement distributing server system according to claim 1 or 2, wherein the brief advertisement image display unit displays the brief advertisement images in the switched manner at each of a plurality of frame areas on the browser screen.

4. The advertisement distributing server system according to claim 3, wherein the plurality of frame areas are displayed in a form of a matrix on the browser screen.

5. The advertisement distributing server system according to claim 4, wherein the brief advertisement image display unit displays the brief advertisement images for the plurality of advertisers on each of the frame areas of the matrix for each genre and displays a genre display area indicating the genre near the frame area on the browser screen, and wherein the brief advertisement image display unit displays each of the brief advertisement images being displayed in the switched manner in a form of a list when the genre display area is selected.

6. The advertisement distributing server system according to any one of claims 1 to 5, wherein the exclusive advertisement page is linked to a homepage which the advertiser owns in other server.

7. An advertisement distributing server system comprising:
a map database which stores a plurality of map information in correspondence with area data;
an advertiser database which stores advertising information which includes area data including a location of a shop of the advertiser, a brief advertisement image and an exclusive advertisement page, for a plurality of advertisers;
a customer database which stores map data designated by a user;
a brief advertisement image display unit which displays the brief advertisement images associated with the plurality of advertisers stored in the advertiser database and map button on a browser screen of the terminal in a switched manner switched at a predetermined time interval in accordance with a request from a client terminal;
a map display unit which displays a map corresponding to the area data designated by the user making an access and an icon indicating the location of the shop of the advertiser on the map on the browser screen when the map button is selected on the browser screen; and
an exclusive advertisement page display unit which displays the exclusive advertisement page of the advertiser associated with the icon on the browser screen when a specific icon on the map displayed on the browser screen is selected.

8. The advertisement distributing server system according to claim 7, wherein the exclusive advertisement page is linked to a homepage which the advertiser owns in other server.

9. An advertisement distributing method performed by an advertisement distributing server system and a client terminal connected to each other via a network, the method comprising:
a step of storing advertising information including brief advertisement images and exclusive advertisement pages in an advertiser database of the advertisement distributing server system for a plurality of advertisers;
a step of displaying the brief advertisement images associated with the plurality of advertisers stored in the advertiser database on a browser screen of the terminal in a switched manner switched at a predetermined time interval in accordance with a request from a client terminal; and
a step of displaying the exclusive advertisement page of the advertiser stored in the advertiser database on the browser screen when a certain brief advertisement image is selected,

10. The advertisement distributing method according to claim 9, wherein the step of displaying the exclusive advertisement pages classifies the brief advertisement images associated with the plurality of advertisers by genre and displayed the classified images at different frame areas on the browser screen, and displays the brief advertisement images associated with the plurality of advertisers in the switched manner with the predetermined time interval.

11. An advertisement distributing method performed by an advertisement distributing server system and a client terminal connected to each other via a network, the method comprising the steps of:
a step of storing a plurality of map information into a map database of the advertisement distributing server system, in correspondence with area data;
a step of storing advertising information which includes area data including a location of a shop of the advertiser, a brief advertisement image and an exclusive advertisement page., into an advertiser database of the advertisement distributing server system, for a plurality of advertisers;
a step of storing map data designated by a user into a customer database of the advertisement distributing server system;
a step of displaying the brief advertisement images associated with the plurality of advertisers stored in the advertiser database and map button on a browser screen of the terminal in a switched manner switched at a predetermined time interval in accordance with a request from a client terminal;
a step of displaying a map corresponding to the area data designated by the user making an access and an icon indicating the location of the shop of the advertiser on the map on the browser screen when the map button is selected on the browser screen; and
a step of displaying the exclusive advertisement page of the advertiser associated with the icon on the browser screen when a specific icon on the map displayed on the browser screen is selected.

12 An advertisement distributing method performed by an advertisement distributing server system and a client terminal connected to each other via a network, the method comprising the steps of:
a step of storing advertising information which includes advertisement contents data to be distributed, and area data and time zone data at which the advertisement is to be distributed, into a database of the advertisement distributing server system;
a step of receiving a designation of area data by a user;
a step of recognizing an access time of the user by the advertisement distributing server system and selecting the advertising information which suits the area data designated by the user and the access time; and
distributing the advertisement contents data included in the selected advertising information from the advertisement distributing server system to the client terminal to display the advertisement contents data on the browser screen.

13. The advertisement distributing method according to claim 11 or 12, wherein the area is specified by using postcode as the area data.

14. An advertisement distributing server system which communicates with a plurality of client terminals via a network, comprising:
an advertisement database which stores an area, a distribution period, a distribution registration date and time at which distribution of an advertisement is registered, an advertisement image and advertisement page designating data;
a display order determining unit which extracts the advertisement whose display time is within the distribution period and which is distributed to a certain area from the plurality of advertisements stored in the advertisement database when the client terminal requested the display, and determines a display order of the advertisement images of the advertisements extracted, based on the distribution registration date and time; and
an advertisement image producing unit which links the advertisement images of the extracted advertisements with the advertisement pages designated by the advertisement page designating data stored in the advertisement database in the order determined by the display order determining unit and produces a web page to be displayed on a screen of the client terminal.

15. The advertisement distributing server system according to claim 14, wherein the display order determining unit determines the display order of the advertisement images from the advertisement image whose distribution registration date and time is newest in an order of the distribution registration date and time is new to old.

16. The advertisement distributing server system according to claim 14 or 15, wherein the advertisement database further stores shops in association with the advertisements, wherein an area is set to each of the shops, and wherein the display order determining unit extracts the advertisements to be distributed to the area by using a shop XD indicating the shop in the advertisement database and an advertisement ID indicating the advertisement image file as a key.

17. The advertisement distributing server system according to claim 14 or 15, wherein the advertisement database further stores shops in association with the advertisements, wherein an area is set in correspondence with an advertiser, and wherein the display order determining unit extracts the advertisement to be distributed to the area in the advertisement database by using an advertiser ID indicating the advertiser and an advertisement ID indicating an advertisement image file.

18. The advertisement distributing server system according to claim 16, wherein the advertisement database further stores advertisers in association with the advertisements, and wherein the display order determining unit extracts the advertisement to be distributed to the area in the advertisement database by using an advertiser ID indicating the advertiser, a shop ID indicating the shop and an advertisement ID indicating an advertisement image file.

19. The advertisement distributing server system according to any one of claims 14 to 18, wherein the advertisement database further stores genre data which classifies the advertisements into any one of a plurality of genres, and wherein the advertisement image display unit determines the display order for each genre and displays the advertisement images of the plurality of genres simultaneously and independently of each other in a single screen.

20. The advertisement distributing server system according to any one of claims 16 to 18, wherein the image files of the advertisement images are stored in the advertisement database in a hierarchical file structure having the plural IDs specifying the advertisements to be distributed as directory name.

21. The advertisement distributing server system according to any one of claims 14 to 20, further comprising an advertisement registering unit for registering at least the advertisement and the area to the advertisement database.

22. The advertisement distributing server system according to any one of claims 14 to 21, wherein the advertisement page designating data is a data designating a homepage in other server.

23. An advertisement distributing method performed by an advertisement server system and a client terminal connected to each other for communication, the method comprising:
a step of registering an advertising information including an area, a distribution period, a distribution registration date and time at which distribution of an advertisement is registered, an advertisement image and advertisement page designating data;
a step of extracting the advertisement whose display time is within the distribution period and which is distributed to a certain area from the plurality of advertisements stored in the advertisement database when the client terminal requested the display, a step of determining a display order of the advertisement images of the advertisements extracted based on the distribution registration date and time;
a step of displaying the extracted advertisement images on the screen of the client terminal at a predetermined time interval in the determined displayed order; and
a step of displaying the advertisement page designated by the data stored in the advertisement database on the screen of the client terminal when a specific advertisement image is selected on the screen.

24. The advertisement distributing method according to claim 23, wherein the step of determining a display order determines the display order from the advertisement image having whose distribution registration date and time is newest in an order that the distribution registration date and time is new to old.
